(19) United States
(12) Patent Application Publication
(10) Pub. No.: US 2006/0120387 A1
(43) Pub. Date: Jun. 8, 2006

(54) Methods and apparatus for processing traffic at a wireless mesh node

(76) Inventor: Liuyang L. Yang, Portland, OR (US)

Correspondence Address: INTEL CORPORATION, P.O. BOX 5326, SANTA CLARA, CA, 95056-5326, US

(21) Appl. No.: 11/003,295

(22) Filed: Dec. 3, 2004

(51) Int. Cl. H04L 12/56; H04L 12/28

(52) U.S. Cl. 370/401; 370/412

(57) ABSTRACT

Embodiments of methods and apparatus for processing traffic at a wireless mesh node are generally described herein. Other embodiments may be described and claimed.

### TECHNICAL FIELD

The present disclosure relates generally to wireless communication systems, and more particularly, to methods and apparatus for processing traffic at a wireless mesh node.

### BACKGROUND

As wireless communication becomes more and more popular at offices, homes, schools, etc., the demand for resources may cause network congestions and slowdowns. To reduce performance degradations and/or overload conditions, a wireless mesh network may be implemented in a wireless communication system. In particular, a wireless mesh network may include two or more nodes. If one node fails to operate properly, the remaining nodes of a wireless mesh network may still be able to communicate with each other either directly or through one or more intermediate nodes. Accordingly, a wireless mesh network may provide multiple paths for a transmission to propagate from the source to the destination. Thus, a wireless mesh network may be a reliable solution to support the increasing demand for wireless communication services.

### BRIEF DESCRIPTION OF THE DRAWINGS

FIG. 1 is a schematic diagram representation of an example wireless communication system according to an embodiment of the methods and apparatus disclosed herein.

FIG. 2 is a block diagram representation of an example mesh node that may be used to implement the example wireless communication system of FIG. 1.

FIG. 3 is a block diagram representation of another example mesh node that may be used to implement the example wireless communication system of FIG. 1

FIG. 4 depicts one manner in which a mesh node may process traffic at a wireless mesh node.

FIG. 5 is a block diagram representation of an example processor system that may be used to implement the example mesh nodes of FIGS. 2 and 3.

### DETAILED DESCRIPTION

In general, methods and apparatus for processing traffic at a wireless mesh node are described herein. According to one example embodiment, a mesh node of a wireless mesh network may identify incoming traffic. In particular, the mesh node may identify the incoming traffic as traffic associated with the wireless mesh network (e.g., mesh forward traffic from other mesh nodes of the wireless mesh network). The mesh node may also identify the incoming traffic as traffic associated with a wireless non-mesh network such as a basic service set (BSS) network. For example, the mesh node may identify the incoming traffic as traffic associated with a station (e.g., a wireless electronic device) of the BSS network. Alternatively, the mesh node may identify the incoming traffic by receiving the traffic associated with the wireless mesh network via a first receiver and receiving the traffic associated with a wireless non-mesh network via a second receiver. Accordingly, the mesh node may associate the identified incoming traffic to a corresponding traffic queue. For example, the mesh node may associate the traffic associated with the wireless mesh network to a mesh traffic queue and associate the traffic associated with a wireless non-mesh network (e.g., a BSS network) to a non-mesh traffic queue. As a result, the traffic associated with the wireless mesh network may be separated from the traffic associated with a wireless non-mesh network. The methods and apparatus described herein are not limited this regard.

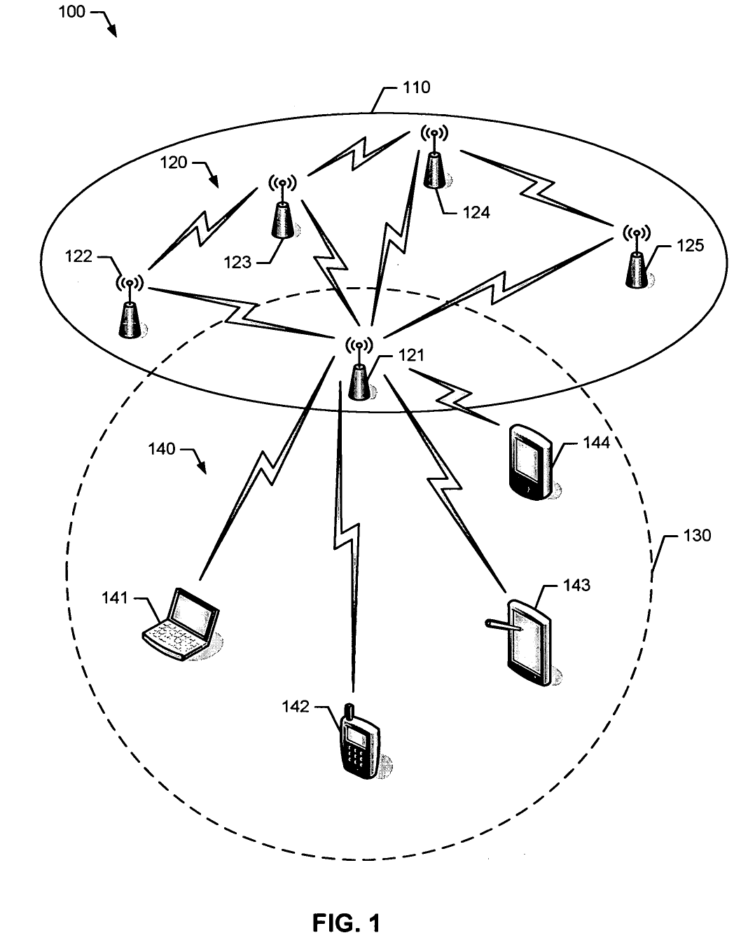

Referring to FIG. 1, an example wireless communication system 100 including a wireless mesh network 110 is described herein. The wireless mesh network 110 may include a plurality of mesh nodes 120, generally shown as 121, 122, 123, 124, and 125. Although FIG. 1 depicts five mesh nodes, the wireless mesh network 110 may include additional or fewer mesh nodes. As described in detail below, the plurality of mesh nodes 120 may include access points, redistribution points, end points, and/or other suitable connection points for traffic flows via mesh paths having multiple hops. Accordingly, the wireless mesh network 110 may be implemented to provide a wireless personal area network (WPAN), a wireless local area network (WLAN), a wireless metropolitan area network (WMAN), a wireless wide area network (WWAN), and/or other suitable wireless communication networks.

The plurality of mesh nodes 120 may use a variety of modulation techniques such as spread spectrum modulation (e.g., direct sequence code division multiple access (DS-CDMA) and/or frequency hopping code division multiple access (FH-CDMA)), time-division multiplexing (TDM) modulation, frequency-division multiplexing (FDM) modulation, orthogonal frequency-division multiplexing (OFDM) modulation, multi-carrier modulation (MDM), and/or other suitable modulation techniques to communicate with each other. In particular, the plurality of mesh nodes 120 may use OFDM modulation as described in the 802.xx family of standards developed by the Institute of Electrical and Electronic Engineers (IEEE) and/or variations and evolutions of these standards (e.g., 802.11x, 802.15, 802.16x, etc.) to communicate via the short-range wireless communication links with each other. The plurality of mesh nodes 120 may also operate in accordance with other suitable wireless communication protocols that require very low power such as Bluetooth, Ultra Wideband (UWB), and/or radio frequency identification (RFID) to communicate with each other (e.g., forward data within the wireless mesh network 110).

The wireless communication system 100 may also include wireless non-mesh networks such as a basic service set (BSS) network (one shown as 130). The BSS network 130 may include one or more stations 140, generally shown as 141, 142, 143, and 144. Although FIG. 1 depicts four stations, the BSS 130 may include additional or fewer stations. For example, the stations 140 may include a laptop computer, a desktop computer, a handheld computer, a tablet computer, a cellular telephone, a pager, an audio/video device (e.g., an MP3 player), a game device, a navigation device (e.g., a GPS device), a monitor, a printer, a server, and/or other suitable wireless electronic devices.

The stations 140 may operate in accordance with one or more of several wireless communication protocols to communicate with the wireless mesh network 110. In particular, these wireless communication protocols may be based on analog, digital, and/or dual-mode communication system standards such as the Global System for Mobile Communications (GSM) standard, the Frequency Division Multiple Access (FDMA) standard, the Time Division Multiple Access (TDMA) standard, the Code Division Multiple Access (CDMA) standard, the Wideband CDMA (WCDMA) standard, the General Packet Radio Services (GPRS) standard, the Enhanced Data GSM Environment (EDGE) standard, the Universal Mobile Telecommunications System (UMTS) standard, variations and evolutions of these standards, and/or other suitable wireless communication standards.

The BSS network 130 may also include access points to provide wireless communication services to the stations 140. In addition to operating as a mesh point within the wireless mesh network 110, each of the plurality of mesh nodes 120 may operate as an access point. For example, the mesh node 121 may operate as a mesh point of the wireless network 110 to communicate with other mesh nodes (e.g., mesh nodes 122, 123, 124, and/or 125). In particular, the mesh node 121 may receive and/or transmit data in connection with the mesh nodes 122, 123, 124, and/or 125. The mesh node 121 may also operate as an access point of the BSS network 130 to communicate with one or more stations 140 (e.g., stations 141, 142, 143, and/or 144). That is, the mesh node 121 may receive and/or transmit data in connection with the stations 141, 142, 143, and/or 144. As a result, the mesh node 121 may operate as a mesh access point to communicate with both the plurality of mesh nodes 120 and the station(s) 140. The methods and apparatus described herein are not limited in this regard.

Further, the wireless communication system 100 may include other wireless local area network (WLAN) devices and/or wireless wide area network (WWAN) devices (not shown) such as network interface devices and peripherals (e.g., network interface cards (NICs)), access points (APs), gateways, bridges, hubs, etc. to implement a cellular telephone system, a satellite system, a personal communication system (PCS), a two-way radio system, a one-way pager system, a two-way pager system, a personal computer (PC) system, a personal data assistant (PDA) system, a personal computing accessory (PCA) system, and/or any other suitable communication system. Although certain examples have been described above, the scope of coverage of this disclosure is not limited thereto.

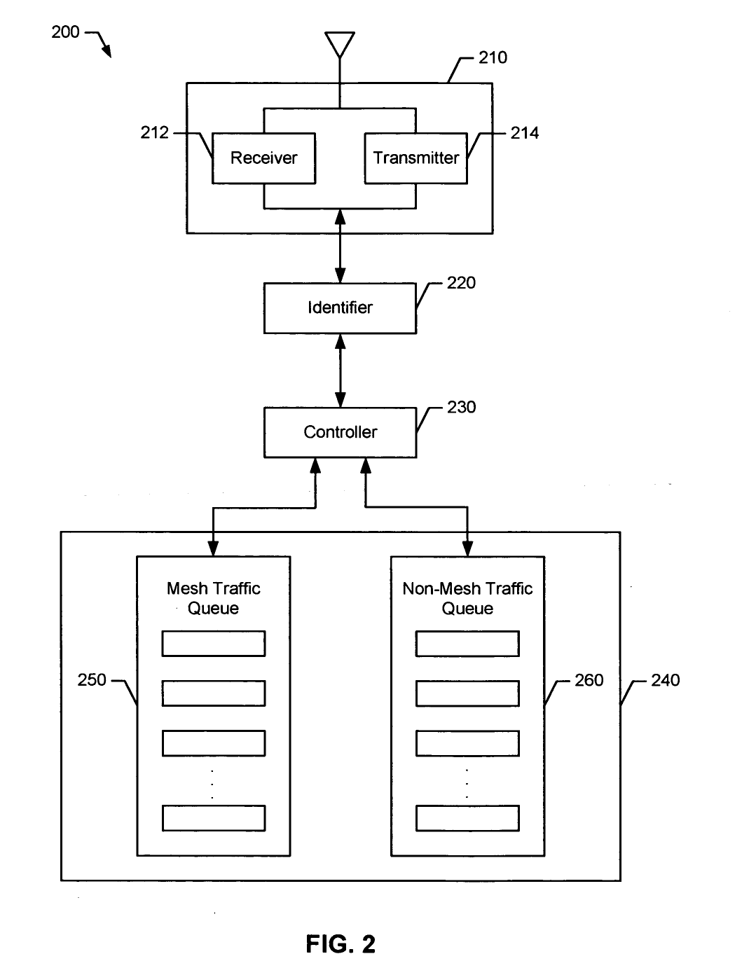

In the example of FIG. 2, a mesh node 200 may include a radio interface 210, an identifier 220, a controller 230, and a memory 240. The radio interface 210 may include a receiver 212 and a transmitter 214. The radio interface 210 may receive traffic associated with wireless communication networks including mesh networks (e.g., the mesh network 110 of FIG. 1) and/or non-mesh networks (e.g., the BSS network 130 of FIG. 1). Although the receiver 212 and the transmitter 214 are depicted as separate blocks within the radio interface 210, the receiver 212 may be integrated into the transmitter 214 (e.g., a transceiver).

The identifier 220 may be operatively coupled to the radio interface 210 and configured to identify traffic received by the radio interface 210 (e.g., incoming traffic). In particular, the identifier 220 may identify the incoming traffic as traffic associated with a wireless mesh network (e.g., mesh forwarding traffic) or traffic associated with a wireless non-mesh network (e.g., BSS data traffic). In one example, the identifier 220 may identify the incoming traffic based on a packet header. The packet header may indicate the source of the incoming traffic.

The controller 230 may be operatively coupled to the identifier 220 and the memory 240. The controller 230 may associate the incoming traffic identified by the identifier 220 to a corresponding traffic queue in the memory 240. In particular, the memory 240 may include a mesh traffic queue 250 and a non-mesh traffic queue 260. Each of the mesh traffic queue 250 and the non-mesh traffic queue 260 may include one or more data structures. Although FIG. 2 depicts four data structures for the each of the mesh traffic queue 250 and the non-mesh traffic queue 260, the mesh and non-mesh traffic queues 250 and 260 may include additional or fewer data structures. For example, the controller 230 may associate and store data of the traffic associated with the wireless mesh network 110 in the mesh traffic queue 250. Accordingly, the controller 230 may associate and store data of the traffic associated with the BSS network 130 in the non-mesh traffic queue 260. Further, the controller 230 may also provide separate quality-of-service (QoS) parameters to the mesh and non-mesh traffic. In one example, the controller 230 may provide an enhanced distributed channel access (EDCA) parameter to the mesh traffic and another EDCA parameter to the non-mesh traffic. As a result, the mesh node 200 may improve network performance by separating the mesh traffic and the non-mesh traffic for prioritization based on a predefined traffic prioritization policy. The methods and apparatus described herein are not limited in this regard.

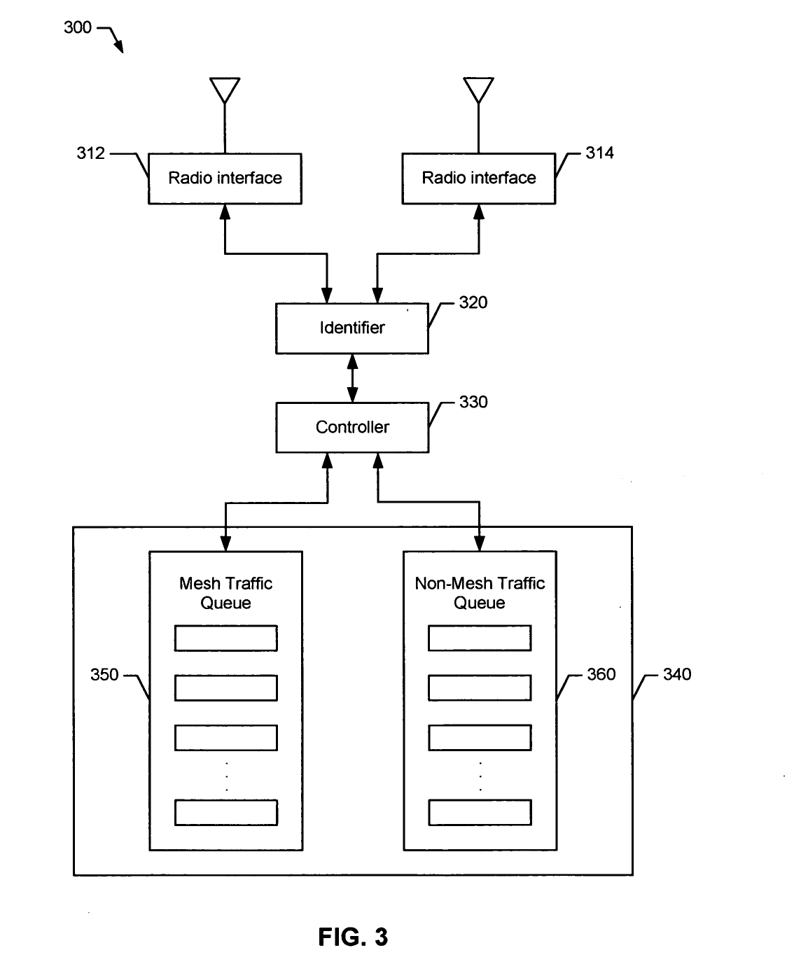

Alternatively, a mesh node may include two or more radio interfaces to receive incoming traffic. Turning to FIG. 3, for example, a mesh node 300 may include a first radio interface 310, a second radio interface 315, an identifier 320, a controller 330, and a memory 340. Each of the radio interfaces 310 and 315 may include a receiver and a transmitter (not shown). The first radio interface 310 may receive traffic from a wireless mesh network such as the wireless mesh network 110 (FIG. 1). The second radio interface 315 may receive traffic from wireless non-mesh networks such as the BSS network 130 (FIG. 1).

The identifier 320 may be operatively coupled to the first and second radio interface 310 and 315. The identifier 320 may identify the incoming traffic received by the first radio interface 310 as traffic associated with a wireless mesh network (e.g., mesh forwarding traffic). Accordingly, the identifier 320 may identify the incoming traffic received by the second radio interface 315 as traffic associated with a wireless non-mesh network (e.g., BSS data traffic).

The controller 330 may be operatively coupled to the identifier 320 and the memory 340. The controller 330 may associate the incoming traffic identified by the identifier 320 to a corresponding traffic queue in the memory 340. In particular, the memory 340 may include a mesh traffic queue 350 and a non-mesh traffic queue 360. Each of the mesh traffic queue 350 and the non-mesh traffic queue 360 may include one or more data structures. For example, the controller 330 may associate and store data of the traffic associated with the wireless mesh network 110 in the mesh traffic queue 350. Accordingly, the controller 330 may associate and store data of the traffic associated with the BSS network 130 in the non-mesh traffic queue 360. As a result, the mesh node 300 may improve network performance by separating the mesh traffic and the non-mesh traffic for prioritization based on a predefined traffic prioritization policy. The methods and apparatus described herein are not limited in this regard.

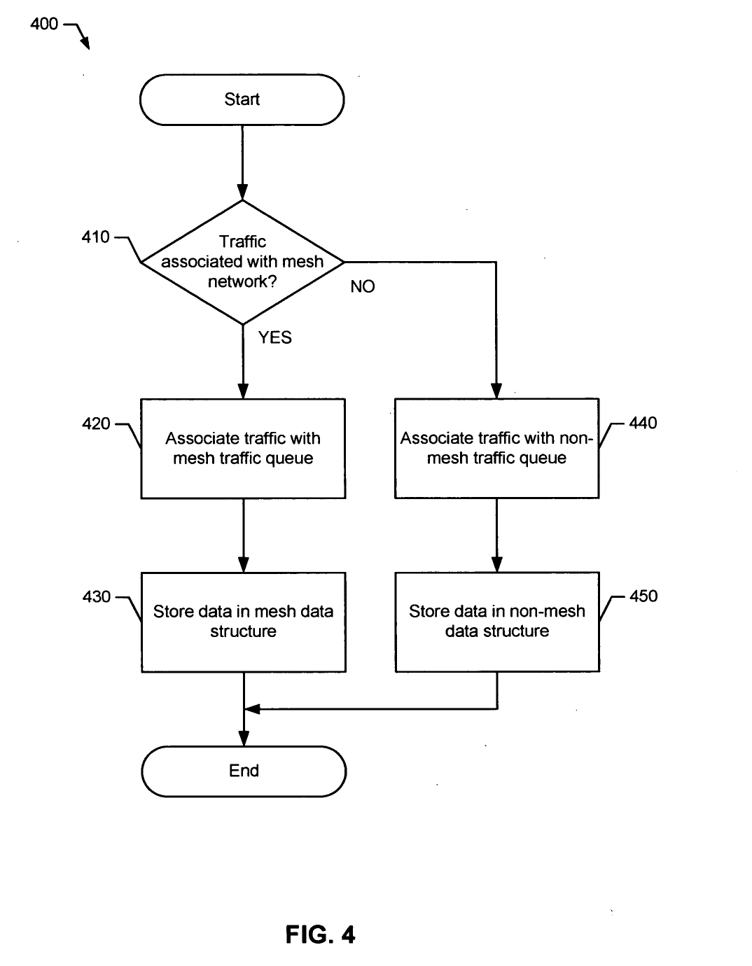

FIG. 4 depicts one manner in which the mesh node 200 of FIG. 2 or the mesh node 300 of FIG. 3 may be configured to process incoming traffic as described herein. The example process 400 of FIG. 4 may be implemented as machine-accessible instructions utilizing any of many different programming codes stored on any combination of machine-accessible media such as a volatile or nonvolatile memory or other mass storage device (e.g., a floppy disk, a CD, and a DVD). For example, the machine-accessible instructions may be embodied in a machine-accessible medium such as a programmable gate array, an application specific integrated circuit (ASIC), an erasable programmable read only memory (EPROM), a read only memory (ROM), a random access memory (RAM), a magnetic media, an optical media, and/or any other suitable type of medium.

Further, although a particular order of actions is illustrated in FIG. 4, these actions can be performed in other temporal sequences. Again, the example process 400 is merely provided and described in conjunction with the apparatus of FIGS. 1, 2, and 3 as an example of one way to configure a mesh node to process incoming traffic.

In the example of FIG. 4, the process 400 begins with a mesh node (e.g., the mesh node 200 of FIG. 2) identifying incoming traffic (block 410). In particular, the mesh node may determine whether the incoming traffic is associated with a wireless mesh network. For example, the identifier 220 (FIG. 2) may identify the incoming traffic based on a packet header indicative of the source. Accordingly, the identifier 220 may identify the incoming traffic as traffic associated with a wireless mesh network (e.g., the wireless mesh network 110 of FIG. 1) or traffic associated with a wireless non-mesh network (e.g., the BSS network 130 of FIG. 1). If the identifier 220 determines that the incoming traffic is traffic associated with the wireless mesh network 110, the controller 230 may associate the incoming traffic with the mesh traffic queue. 250 (block 420). Accordingly, the controller 230 may store data of the incoming traffic in a mesh data structure of the mesh traffic queue 250 (block 430).

Otherwise if the identifier 220 determines that the incoming traffic is traffic associated with the BSS network 130, the controller 230 may associate the incoming traffic with the non-mesh traffic queue 260 (block 440). Thus, the controller 230 may store data of the incoming traffic in a non-mesh data structure of the non-mesh traffic queue 260 (block 450.

Referring back to block 410, for another example, the identifier 320 (FIG. 3) may identify the incoming traffic based on whether the mesh node 300 received the incoming traffic via the first radio interface 310 or via the second radio interface 315. As noted above, the first radio interface 310 may receive traffic associated with the wireless mesh network 110 and the second radio interface 315 may receive traffic associated with the wireless non-mesh network 130. If the mesh node 300 received the incoming traffic via the first radio interface 310, the identifier 320 may identify the incoming traffic as traffic associated with the wireless mesh network 110. Accordingly, the controller 330 may associate and store the incoming traffic with the mesh traffic queue 350 (blocks 420 and 430). Otherwise if the mesh node 300 received the incoming traffic via the second radio interface 315, the identifier 320 may identify the incoming traffic as traffic associated with the BSS network 130. The controller 330 may associate and store the incoming traffic with the non-mesh traffic queue 360 (blocks 440 and 450). The methods and apparatus described herein are not limited this regard.

Although the methods and apparatus disclosed herein are well suited for voice calls and/or messages, the methods and apparatus disclosed herein are readily applicable to many other types of communication services such as short messaging service (SMS), enhanced messaging service (EMS), multimedia messaging service (MMS), etc. For example, the methods and apparatus disclosed herein may be implemented to wireless communication systems that support communication of text, images, streaming audio/video clips, and/or any other multimedia applications. The methods and apparatus described herein are not limited in this regard.

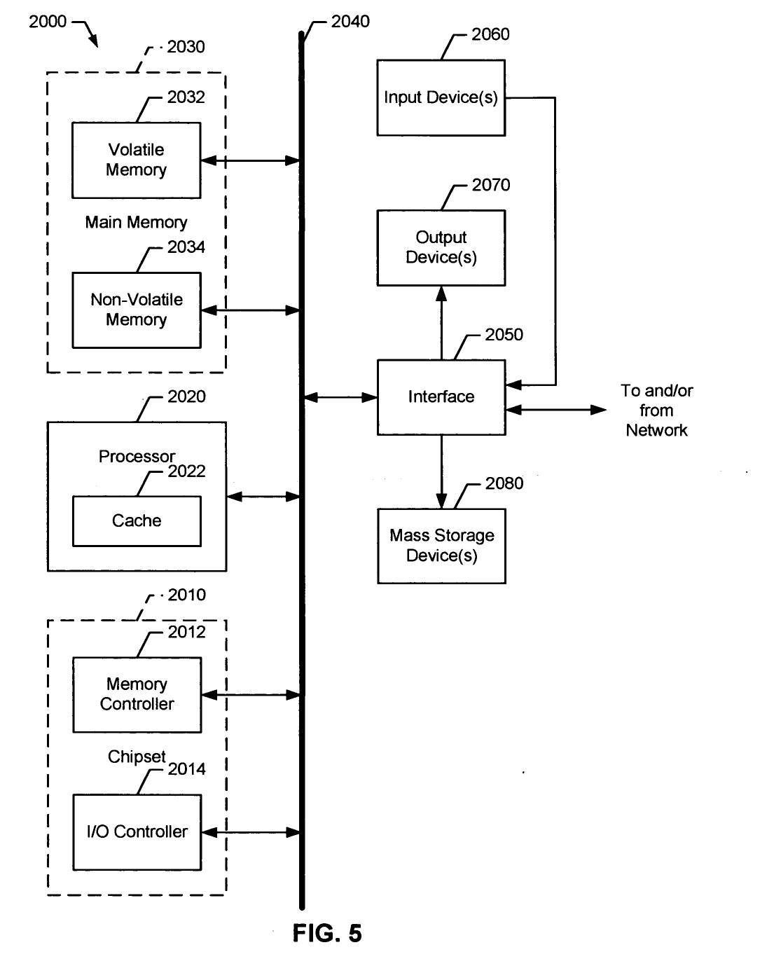

FIG. 5 is a block diagram of an example processor system 2000 adapted to implement the methods and apparatus disclosed herein. The processor system 2000 may be a desktop computer, a laptop computer, a handheld computer, a tablet computer, a PDA, a server, an Internet appliance, and/or any other type of computing device.

The processor system 2000 illustrated in FIG. 5 includes a chipset 2010, which includes a memory controller 2012 and an input/output (I/O) controller 2014. The chipset 2010 may provide memory and I/O management functions as well as a plurality of general purpose and/or special purpose registers, timers, etc. that are accessible or used by a processor 2020. The processor 2020 may be implemented using one or more processors, WLAN components, WMAN components, WWAN components, and/or other suitable processing components. For example, the processor 2020 may be implemented using one or more of the Intel® Pentium® technology, the Intel® Itanium® technology, the Intel® Centrino™ technology, the Intel® Xeon™ technology, and/or the Intel® XScale® technology. In the alternative, other processing technology may be used to implement the processor 2020. The processor 2020 may include a cache 2022, which may be implemented using a first-level unified cache (L1), a second-level unified cache (L2), a third-level unified cache (L3), and/or any other suitable structures to store data.

The memory controller 2012 may perform functions that enable the processor 2020 to access and communicate with a main memory 2030 including a volatile memory 2032 and a non-volatile memory 2034 via a bus 2040. The volatile memory 2032 may be implemented by Synchronous Dynamic Random Access Memory (SDRAM), Dynamic Random Access Memory (DRAM), RAMBUS Dynamic Random Access Memory (RDRAM), and/or any other type of random access memory device. The non-volatile memory 2034 may be implemented using flash memory, Read Only Memory (ROM), Electrically Erasable Programmable Read Only Memory (EEPROM), and/or any other desired type of memory device.

The processor system 2000 may also include an interface circuit 2050 that is coupled to the bus 2040. The interface circuit 2050 may be implemented using any type of interface standard such as an Ethernet interface, a universal serial bus (USB), a third generation input/output interface (3GIO) interface, and/or any other suitable type of interface.

One or more input devices 2060 may be connected to the interface circuit 2050. The input device(s) 2060 permit an individual to enter data and commands into the processor 2020. For example, the input device(s) 2060 may be implemented by a keyboard, a mouse, a touch-sensitive display, a track pad, a track ball, an isopoint, and/or a voice recognition system.

One or more output devices 2070 may also be connected to the interface circuit 2050. For example, the output device(s) 2070 may be implemented by display devices (e.g., a light emitting display (LED), a liquid crystal display (LCD), a cathode ray tube (CRT) display, a printer and/or speakers). The interface circuit 2050 may include, among other things, a graphics driver card.

The processor system 2000 may also include one or more mass storage devices 2080 to store software and data. Examples of such mass storage device(s) 2080 include floppy disks and drives, hard disk drives, compact disks and drives, and digital versatile disks (DVD) and drives.

The interface circuit 2050 may also include a communication device such as a modem or a network interface card to facilitate exchange of data with external computers via a network. The communication link between the processor system 2000 and the network may be any type of network connection such as an Ethernet connection, a digital subscriber line (DSL), a telephone line, a cellular telephone system, a coaxial cable, etc.

Access to the input device(s) 2060, the output device(s) 2070, the mass storage device(s) 2080 and/or the network may be controlled by the I/O controller 2014. In particular, the I/O controller 2014 may perform functions that enable the processor 2020 to communicate with the input device(s) 2060, the output device(s) 2070, the mass storage device(s) 2080 and/or the network via the bus 2040 and the interface circuit 2050.

While the components shown in FIG. 5 are depicted as separate blocks within the processor system 2000, the functions performed by some of these blocks may be integrated within a single semiconductor circuit or may be implemented using two or more separate integrated circuits. For example, although the memory controller 2012 and the I/O controller 2014 are depicted as separate blocks within the chipset 2010, the memory controller 2012 and the I/O controller 2014 may be integrated within a single semiconductor circuit.

Although certain example methods, apparatus, and articles of manufacture have been described herein, the scope of coverage of this disclosure is not limited thereto. On the contrary, this disclosure covers all methods, apparatus, and articles of manufacture fairly falling within the scope of the appended claims either literally or under the doctrine of equivalents. For example, although the above discloses example systems including, among other components, software or firmware executed on hardware, it should be noted that such systems are merely illustrative and should not be considered as limiting. In particular, it is contemplated that any or all of the disclosed hardware, software, and/or firmware components could be embodied exclusively in hardware, exclusively in software, exclusively in firmware or in some combination of hardware, software, and/or firmware.

What is claimed is:

1. A method comprising:
identifying incoming traffic;
associating traffic associated with a first wireless communication network in a first queue at a mesh node; and
associating traffic associated with a second wireless communication network in a second queue at the mesh node.

2. A method as defined in claim 1, wherein identifying the incoming traffic comprises identifying one of traffic associated with a wireless mesh network or traffic associated with a wireless non-mesh network.

3. A method as defined in claim 1, wherein identifying the incoming traffic comprises identifying the incoming traffic based on a packet header.

4. A method as defined in claim 1, wherein identifying the incoming traffic comprises one of receiving traffic associated with a wireless mesh network via a first receiver at the mesh node or receiving traffic associated with a wireless non-mesh network via a second receiver at the mesh node.

5. A method as defined in claim 1, wherein identifying the incoming traffic comprises identifying traffic associated with a basic service set network.

6. A method as defined in claim 1, wherein identifying the incoming traffic comprises identifying the incoming traffic at a mesh access point.

7. A method as defined in claim 1, wherein associating the traffic associated with the first wireless communication network in the first queue at the mesh node comprises storing traffic data in a data structure associated with a wireless mesh network at the mesh node.

8. A method as defined in claim 1, wherein associating the traffic associated with the second wireless communication network in the second queue at the mesh node comprises storing traffic data in a data structure associated with a wireless non-mesh network at the mesh node.

9. An article of manufacture including content, which when accessed, causes a machine to:
identify incoming traffic;
associate traffic associated with a first wireless communication network in a first queue at a mesh node; and
associate traffic associated with a second wireless communication network in a second queue at the mesh node.

10. An article of manufacture as defined in claim 9, wherein the content, when accessed, causes the machine to identify the incoming traffic by identifying one of traffic associated with a wireless mesh network or traffic associated with a wireless non-mesh network.

11. An article of manufacture as defined in claim 9, wherein the content, when accessed, causes the machine to identify the incoming traffic by identifying the incoming traffic based on a packet header.

12. An article of manufacture as defined in claim 9, wherein the content, when accessed, causes the machine to identify the incoming traffic at the mesh node by one of receiving traffic associated with a wireless mesh network via a first receiver or receiving traffic associated with a wireless non-mesh network via a second receiver.

13. An article of manufacture as defined in claim 9, wherein the content, when accessed, causes the machine to identify the incoming traffic by identifying traffic associated with a basic service set network.

14. An article of manufacture as defined in claim 9, wherein the content, when accessed, causes the machine to identify the incoming traffic by identifying the incoming traffic at a mesh access point.

15. An article of manufacture as defined in claim 9, wherein the content, when accessed, causes the machine to associate the traffic associated with the first wireless communication network in the first queue at the mesh node by storing traffic data in a data structure associated with a wireless mesh network at the mesh node.

16. An article of manufacture as defined in claim 9, wherein the content, when accessed, causes the machine to associate the traffic associated with the second wireless communication network in the second queue at the mesh node by storing traffic data in a data structure associated with a wireless non-mesh network at the mesh node.

17. An apparatus comprising:
an identifier to identify incoming traffic;
a controller to associate traffic associated with a first wireless communication network in a first queue at a mesh node, and to associate traffic associated with a second wireless communication network in a second queue at the mesh node.

18. An apparatus as defined in claim 17, wherein the incoming traffic comprises one of traffic associated with a wireless mesh network or traffic associated with a wireless non-mesh network.

19. An apparatus as defined in claim 17, wherein the incoming traffic comprises traffic associated with a basic service set network.

20. An apparatus as defined in claim 17, wherein the identifier is configured to identify the incoming traffic based on a packet header.

21. An apparatus as defined in claim 17 further comprising a first receiver to receive traffic associated with a wireless mesh network and a second receiver to receive traffic associated with a wireless non-mesh network.

22. An apparatus as defined in claim 17, wherein the mesh node comprises a mesh access point.

23. An apparatus as defined in claim 17, wherein the controller is configured to store traffic data in a data structure associated with a wireless mesh network and to store traffic data in a data structure associated with a wireless non-mesh network.

24. A system comprising:
a flash memory; and
a processor coupled to the flash memory to identify incoming traffic, to store traffic associated with a first wireless communication network in a first queue at a mesh node, and to store traffic associated with a second wireless communication network in a second queue at the mesh node.

25. A system as defined in claim 24, wherein the incoming traffic comprises one of traffic associated with a wireless mesh network or traffic associated with a wireless non-mesh network.

26. A system as defined in claim 24, wherein the incoming traffic comprises the incoming traffic comprises traffic associated with a basic service set network.

27. A system as defined in claim 24, wherein the processor is configured to identify the incoming traffic at the mesh node based on a packet header.

28. A system as defined in claim 24, wherein the processor is configured to receive traffic associated with a wireless mesh network via a first receiver and to receive traffic associated with a wireless non-mesh network via a second receiver.

29. A system as defined in claim 24, wherein the mesh node comprises one of a mesh access point.

30. A system as defined in claim 24, wherein the processor is configured to store traffic data in a data structure associated with a wireless mesh network and to store traffic data in a data structure associated with a wireless non-mesh network.
